(19) United States
(12) Patent Application Publication
(10) Pub. No.: US 2022/0304482 A1
(43) Pub. Date: Sep. 29, 2022

(54) MODULAR MULTI ACCESSORY FURNITURE DISPLAY SYSTEM

(71) Applicant: ME SALVE, INC., Toa Baja, PR (US)

(72) Inventor: Jose Otero Zambrana, San Juan, PR (US)

(21) Appl. No.: 17/573,610

(22) Filed: Jan. 11, 2022

Related U.S. Application Data
(60) Provisional application No. 63/112,619, filed on Nov. 11, 2020.

(51) Int. Cl. A47F 5/00; G09F 7/18

(52) U.S. Cl. CPC A47F 5/0006; A47F 5/0068; G09F 7/18; G09F 2007/1843

(57) ABSTRACT

A modular display system is provided that incorporates a dual hook arrangement for coupling the components of the display system in different ways using a dual hook element. Tube arms include the dual hook element on one end having a pair of hooking parts configured to be inserted inside openings on a grid panel of the display system and a secondary hooking part configured to be coupled to a loading bar of the grid panel of the display system. Another end of the tube arms is provided with an inserting tab configured to be engage with a receiving base on the frame of a price tape or an advertisement element. The modular display system also includes shelves and drawers/cabinets provided with hooks or dual hook elements to selectively couple them to the grid panel of the display system in various configurations.

### FIELD OF THE INVENTION

The present invention relates to retail display system and, in particular, to a modular product support system. The system provides tube arms, shelves, drawers, advertising, and price frames that can be interchangeable with hook or a dual hook element.

### BACKGROUND OF THE INVENTION

Display assemblies are provided to support retail products and can be made of free-standing wire/rods assemblies or wall assemblies. Current display systems are provided with standard fixed dimensions and configurations. However, support racks with fixed dimensions are limited to a certain display arrangement. Moreover, different support racks are needed for different arrangements, so it is also necessary to include specific display attachments. Some support racks include various elements, such as hinged, cantilevered arms, lateral end walls or dividers and longitudinal dividers. However, a relatively limited number of adjustments and display arrangements are provided by these racks.

Therefore, what is needed is a modular display system that incorporates a dual hook arrangement that increases the number of display arrangement options while allowing the components of the display system to be coupled in different ways using a dual hook element.

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 shows a sign holder according to the present invention.

FIG. 2 shows a base shelf according to the present invention.

FIG. 3 shows a base cabinet and base drawer combo according to the present invention.

FIG. 3A shows a rear view of the base cabinet and base drawer combo with a hook element according to the present invention.

FIG. 4 shows a shelf according to the present invention.

FIG. 4A shows a front view of the shelf with dividing walls inserted according to the present invention.

FIG. 5 shows an advertising frame according to the present invention.

FIG. 6 shows a tube arm with a hook element according to the present invention.

FIG. 7 shows another tube arm with a hook element according to the present invention.

FIG. 8 shows a price tape according to the present invention.

FIGS. 9A and 9B show the structural relationship between a tube arm and the price tape frame according to the present invention.

FIG. 10 shows a modular multi accessory furniture display system according to the present invention.

FIG. 11 shows a multilevel stand according to the present invention.

Throughout the figures, the same reference numbers, and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

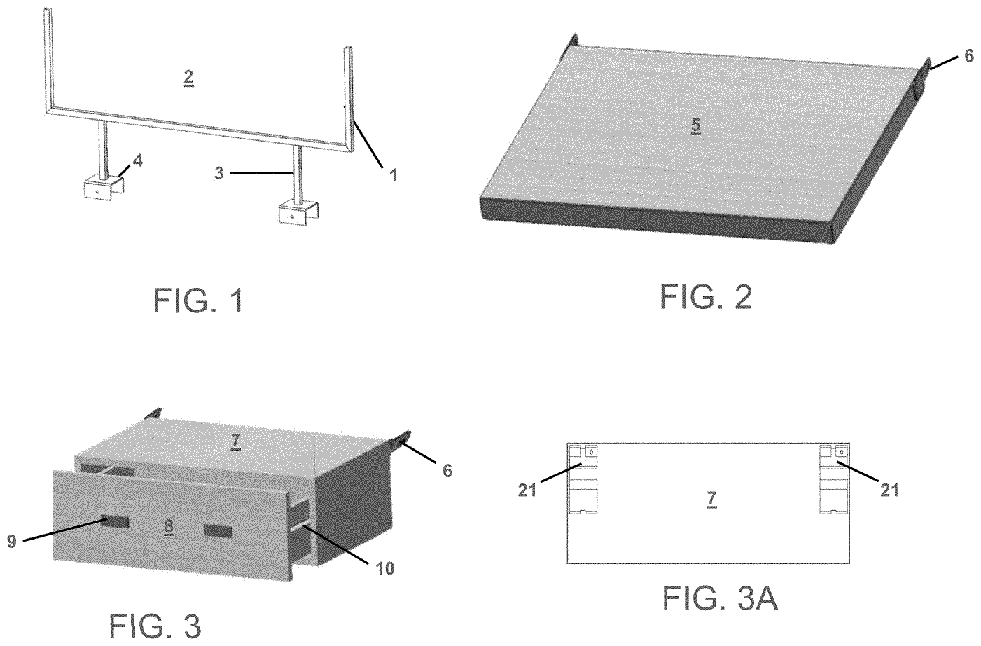

The invention provides a modular multi accessory furniture for commercial products display. FIG. 1 shows a sign holder 1 for a grid panel center. According to an embodiment, the sign holder 1 includes an acrylic panel 2 provided in the middle of the frame as shown in FIG. 1. The acrylic panel 2 can be removably inserted inside a rail provided within the frame. Alternatively, the frame can be integrally manufactured to the frame. An end of a pair of legs 3 is provided at a bottom part of the frame and the other end is provided with a securing base 4. In an embodiment of the invention, the securing base 4 has a U-shaped form configured to receive within a portion of a rack. At least one passthrough aperture is provided on the sides of the securing base so that a securing element such as but not limited to a screw is used to removably secure the securing base to the rack.

FIG. 2 shows a base shelf 5 according to the present invention. In an embodiment, the base shelf 5 is provided without brackets and with ribs 6 as shown in FIG. 2. The ribs 6 can be integrally manufactured into the base shelf 5 or alternatively can be removably fixed to a side portion of the base shelf 5. Ribs 6 comprise hooks that are configured to be inserted into openings of a grid panel so that the base shelf 5 remains fixed in place to support products. The ribs 6 can also be provided at an inclination angle so that the base shelf 5 is relatively inclined at angle other than 90° with relation to the grid panel. The base shelf 5 can be made of a solid material or alternatively can be made with a hollow center. According to a preferred embodiment, the base shelf 5 has a wood finish that can be achieved by covering the surfaces of the base shelf 5 with a material simulating wood or alternatively the base shelf 5 can be made from wood. According to another embodiment, the ribs 6 of the base shelf can be replaced with a hook element 21 provided at a rear portion of the base shelf.

FIG. 3 shows a base cabinet and base drawer combo. Specifically, a drawer 7 is provided with a door/lid 8 having at least one operator 9 configured to manually open or close the drawer by pulling or pushing the drawer from the cabinet by means of the operator 9. A sliding mechanism 10 is further provided to allow the drawer to easily slide from and into the cabinet. In an embodiment the sliding mechanism 10 comprises a slide rail with ball bearing. In another embodiment, the sliding mechanism 10 comprises a slit and a longitudinal tab protruding from a side surface and configured to slide inside the slit. The rear portion of the cabinet is provided with hooks 6 configured to be inserted into openings of a grid panel so that the base cabinet and base drawer combo remains fixed in relation to the grid panel. According to another embodiment, rear portion of the cabinet is provided with a hook element 21 which is described in detail below.

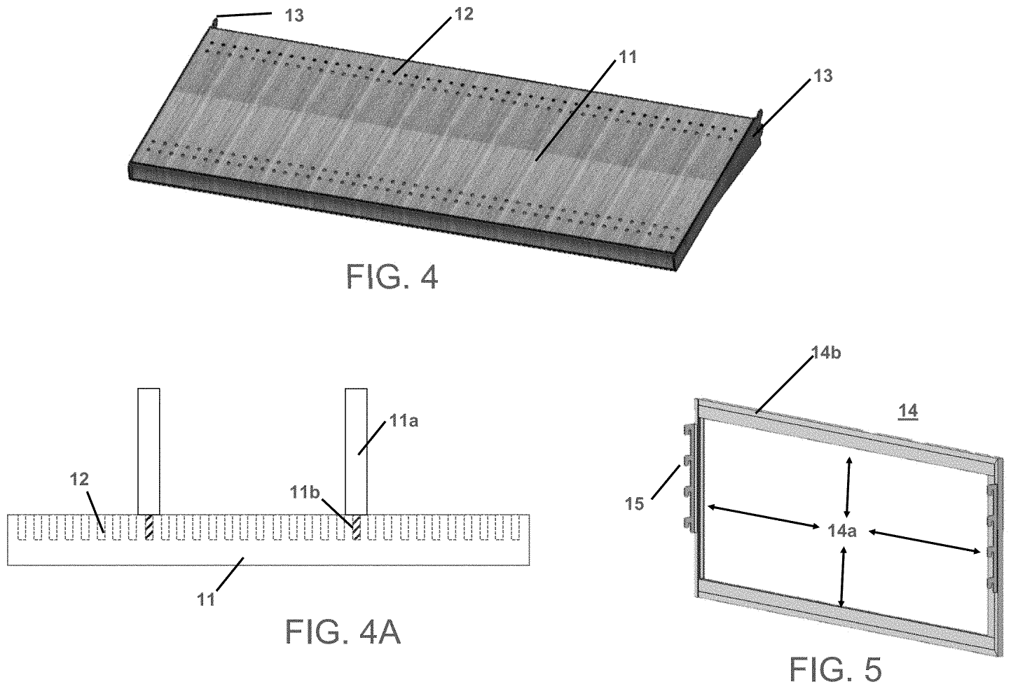

FIG. 4 shows a shelf 11 having ribs 13 that can be integrally manufactured into the shelf 11 or alternatively can be removably fixed to a side portion of the shelf 11. Ribs 13 comprise hooks that are configured to be inserted into openings of a grid panel so that the shelf 11 remains fixed in place to support products. The ribs 13 can also be provided at an inclination angle so that the shelf 11 is relatively inclined at angle other than 90° with relation to the grid panel. In a preferred embodiment, shelf 11 is made from a solid material such as but not limited to metal and has a wood finish that can be achieved by covering the surfaces of the shelf 11 with a material simulating wood. As can be appreciated, the shelf 11 can be provided with a plurality of openings 12 on an upper surface of the shelf 11. According to an embodiment, the openings 12 are configured to receive within a pin 11b provided on an external accessory 11a to removably fix the external accessory 11a to the shelf 11. The external accessory can be for example, a dividing panel 11a including the pins 11b that are inserted inside the openings 12 so that dividing panel 11a divides or separates products positioned on the shelf 11 as shown in FIG. 4A.

FIG. 5 shows an advertising frame 14 having a plurality of hooks 15 that are configured to be inserted into openings of a grid panel so that the advertising frame 14 remains fixed in place to the grid panel. A longitudinal opening 14b is provided along a side of the advertising frame 14 to receive an advertising information sheet inside an area 14a defined by an empty space within the advertising frame 14. The opening 14b can be provided on an upper or a lateral side of the advertising frame 14 so that the borders of the advertising information sheet are inserted into slits provided on the interior surfaces of the remaining sides facing towards the area 14a.

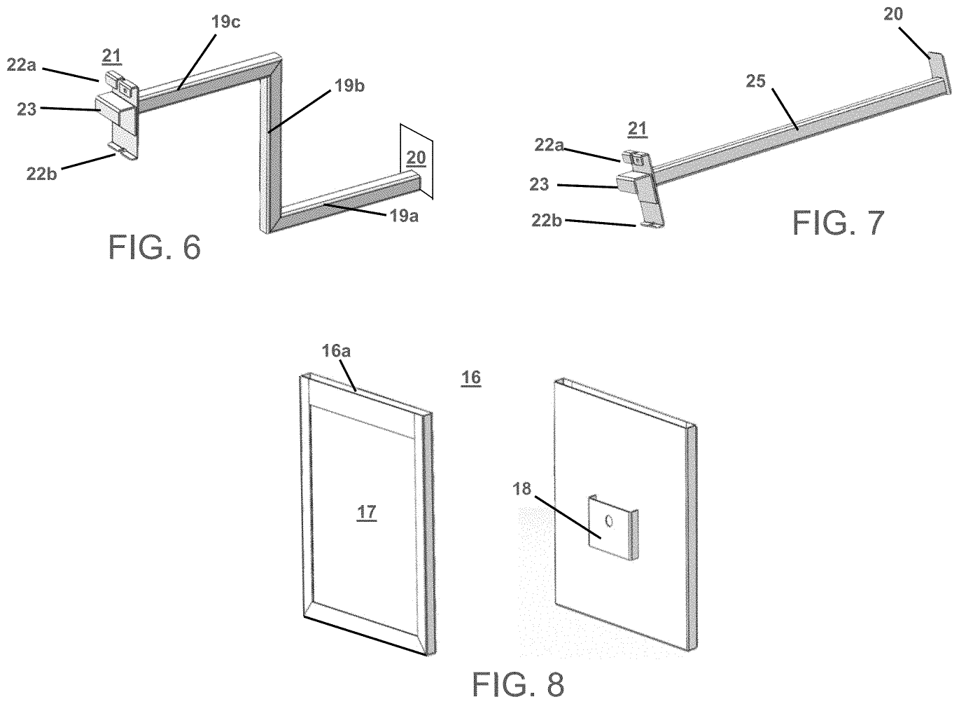

FIGS. 6 and 7 show embodiments of a tube arm with a dual-hook arrangement for both a grid panel and a loading bar fixing. FIG. 6 shows a tube arm comprising a first horizontal tube 19a having a first end with an inserting tab 20 and a second end coupled to an end of a second vertical arm 19b. The other end of the second vertical arm 19b is coupled to a first end of a third horizontal arm 19c and the other end of the horizontal arm 19c is coupled to a hook element 21. As can be appreciated, the hook element 21 comprises hooking parts 22a/22b configured to be inserted inside openings on the grid panel. The hook element 21 further comprises secondary hooking part 23 configured to be coupled to a loading bar or an upper panel of a product display wall or rack. According to another embodiment, FIG. 7 shows a tube arm comprising a single horizontal tube 25 having a first end with an inserting tab 20 and a second end coupled to a hook element 21. As can be appreciated, the hook element 21 comprises hooking parts 22a/22b configured to be inserted inside openings on the grid panel. The hook element 21 further comprises secondary hooking part 23 configured to be coupled to a loading bar of a product display wall or rack.

FIG. 8 shows a price tape frame 16 with a receiving base 18 configured to receive within the inserting tab 20 of the tube arms shown in FIGS. 6 and 7. The receiving base 18 is provided with at least one passthrough aperture configure to receive a securing element such as but not limited to a screw used to removably secure the frame 16 to the inserting tab 20. A longitudinal opening 16a is provided along a side of the frame 16 to receive price information sheet or tape inside the frame 16. The opening 16a can be provided on an upper or a lateral side of the frame 16 so that the price sheet or tape is inserted the frame 16.

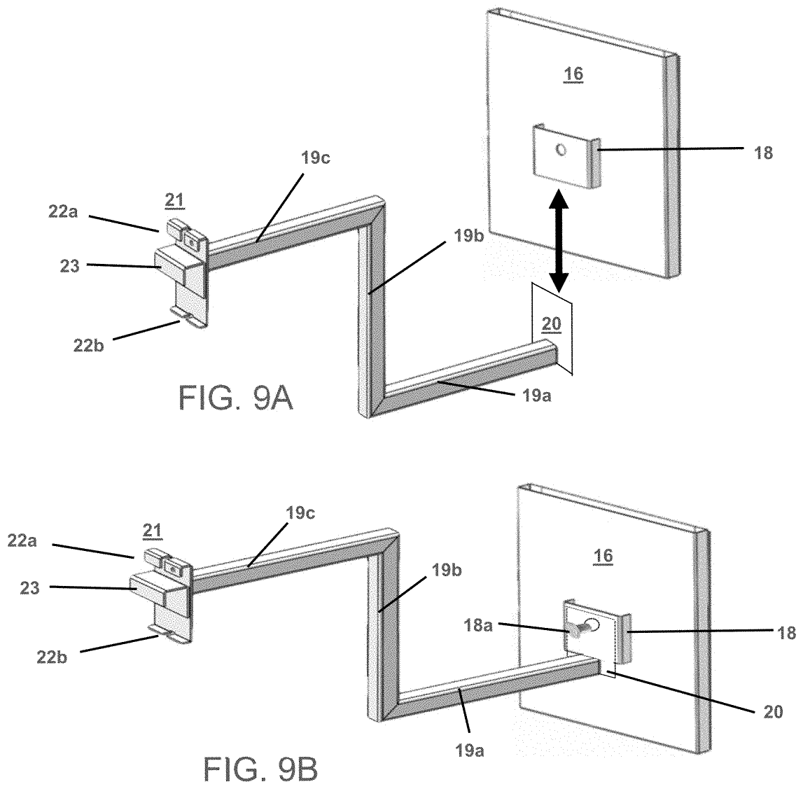

FIGS. 9A and 9B illustrate the structural relationship between the tube arm shown in FIGS. 6 and the price tape frame 16 shown in FIG. 8. The same structural relationship applies to the tube arm shown in FIG. 7. As can be appreciated, the tab 20 is inserted inside the receiving base 18 and a screw 18a is inserted through the opening of the receiving base 18.

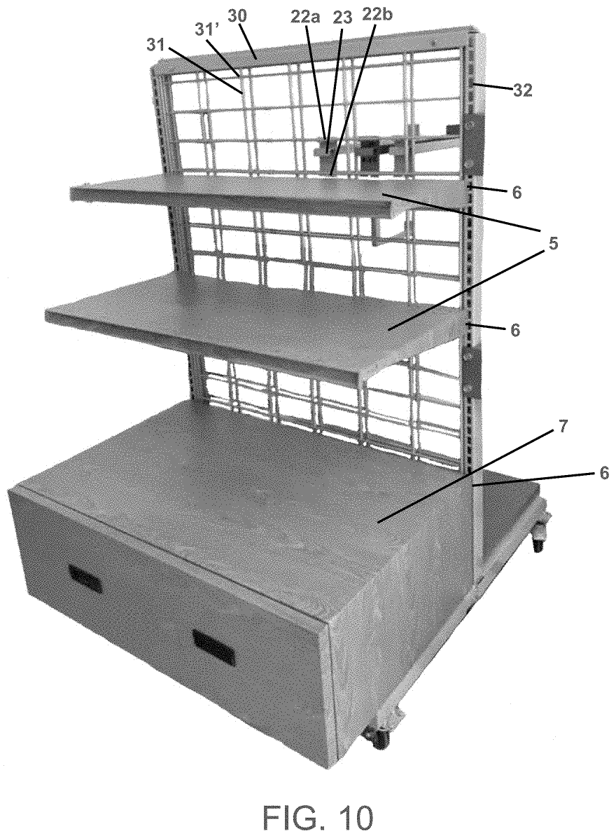

FIG. 10 shows a modular multi accessory furniture display system according to an embodiment of the invention. A grid panel center is shown having an upper border panel 30 and a plurality of horizontal and vertical rods 31 forming a grid arrangement. Two side panels include a plurality of receiving openings 32 configured to receive the hooks 6 provided on the rear surface of the base shelf 5, the shelf 11 and the drawer 7. The tube arms are shown coupled to a back portion of the grid panel center where the hook element 21 have the hooking part 22a coupled to a horizontal rod 31 and the hooking part 22b coupled to another horizontal rod 31 as shown in the figure. However, according to an important aspect of the invention the hook element 21 has a dual coupling feature such that alternatively, the secondary hooking part 23 is coupled to a loading or upper bar 30 and the hooking part 22b is coupled to a horizontal rod 31′. While the figure shows a loading or upper bar 30 provided at the top of the grid panel center, it is also possible to provide additional bars 30 throughout the height of the grid panel center. As previously explained, it is also envisioned that the hooks 6/13 can be replaced by hook elements 21 so that the shelves 5/11 and the drawer 7 can be coupled to the grid panel center in the same manner as previously explained with the tube arms.

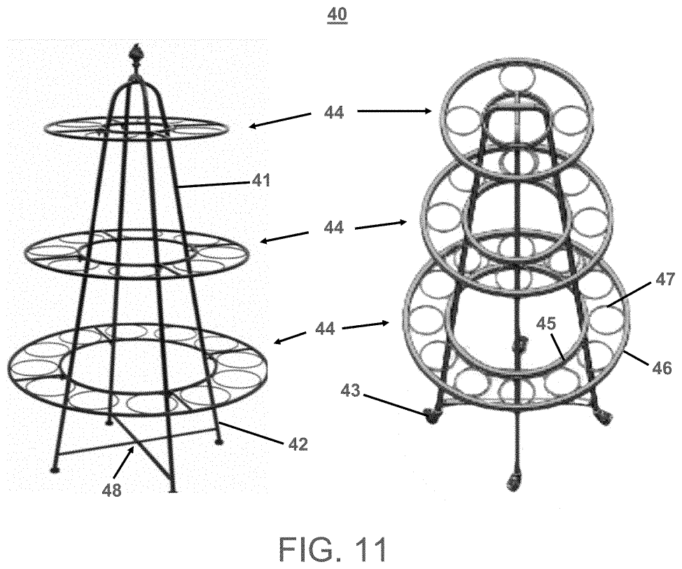

FIG. 11 shows a multilevel stand 40 configured to hold a plurality of plant pots or flowerpots (not shown). Specifically, the stand includes a center frame 41, which according to an embodiment is provided with wheels 43 at the bottom ends of the legs 42. The wheels can be removably attached and can also include a lock mechanism or latch to prevent the multilevel stand from moving. A plurality of circular holding elements 44 being configured to receive at least one pot are provided on top of each other along the vertical length of the central frame 41. Specifically, each circular holding element 44 comprises: an inner border ring 45 attached to the central frame 41; an outer border ring 46 parallel to said inner border ring 45; and at least one pot holding element 47 attached between said inner border ring 45 and said outer border ring 46. In a preferred embodiment the multilevel stand 40 comprises 4 legs. However, it is envisioned that the multilevel stand can comprise 3 and 5 or more legs. Moreover, any number of circular holding elements 44 other than 3 can be provided. Furthermore, any number of pot holding elements 47 can be provided on the circular holding elements 44. As can be appreciated, in the preferred embodiment a structural support arrangement 48 is provided coupling the legs 42 of the stand at the bottom of the stand.

Although the present invention has been described herein with reference to the foregoing exemplary embodiment, this embodiment does not serve to limit the scope of the present invention. Accordingly, those skilled in the art to which the present invention pertains will appreciate that various modifications are possible, without departing from the technical spirit of the present invention.

1. A dual hook element comprising:
a single piece element having a flat base and a pair of upper inverted U-shaped hook elements protruding from said flat base, said pair of upper inverted U-shaped hook elements being separated by an upper opening; a pair of lower tabs protruding from said flat base in the same direction as the pair of upper inverted U-shaped hook elements, said pair of lower tabs is provided below said pair of upper inverted U-shaped hook elements, wherein said pair of lower tabs is separated by a lower opening that is oriented to coincide with the upper opening separating said pair of upper inverted U-shaped hook elements; and a secondary hook element having an inverted U shape protruding from said flat base in the same direction as the pair of upper inverted U-shaped hook elements and being provided between said pair of upper inverted U-shaped hook elements and said pair of lower tabs.

2. The dual hook element according to claim 1, wherein an end of a tube arm protrudes from a rear surface of the flat base opposite to said pair of upper inverted U-shaped hook elements and another end of said tube arm comprises an inserting tab perpendicular to said tube arm.

3. The dual hook element according to claim 3, wherein said tube arm comprises a first horizontal tube portion protruding from said rear surface, a vertical tube portion coupled to an end of said first horizontal tube portion; and a second horizontal tube portion coupled to another end of said vertical tube portion, wherein an end of said second horizontal tube portion comprises said inserting tab.

4. The dual hook element according to claim 1, wherein a rear surface of a shelf is coupled to a rear surface of the flat base opposite to said pair of upper inverted U-shaped hook elements.

5. The dual hook element according to claim 1, wherein a rear surface of a cabinet or drawer is coupled to a rear surface of the flat base opposite to said pair of upper inverted U-shaped hook elements.

6. The dual hook element according to claim 2, wherein said inserting tab is configured to be inserted inside a receiving element having a receiving opening provided on a rear surface of at least one of an advertisement frame or a price indication frame.

7. The dual hook element according to claim 6, wherein said at least one of an advertisement frame or a price indication frame includes a longitudinal opening configured to allow insertion of an information sheet inside said at least one of an advertisement frame or a price indication frame.

8. The dual hook element according to claim 6, wherein a securing element is inserted through said receiving opening in order to secure said inserting tab against said rear surface of the at least one of an advertisement frame or a price indication frame.

9. The dual hook element according to claim 1, wherein said pair of upper inverted U-shaped hook elements are coupled to a horizontal rod of a grid panel center of a furniture display system and said pair of lower tabs are coupled to another horizontal rod of the grid panel center below said horizontal rod, so that a same vertical rod of said grid panel center is received within said upper opening and said lower opening.

10. The dual hook element according to claim 1, wherein said secondary hook element is coupled to a panel of a grid panel center of a furniture display system and said pair of lower tabs are coupled to a horizontal rod of the grid panel center below said panel, so that a vertical rod of said grid panel center is received within said lower opening.

11. The dual hook element according to claim 4, wherein said shelf comprises a plurality of cavities provided on an upper surface of the shelf.

12. The dual hook element according to claim 11, wherein said plurality of cavities is configured to receive a plurality of tabs provided on an attachment element.

13. The dual hook element according to claim 12, wherein said attachment element comprises a dividing wall.
